(19) United States
(12) Patent Application Publication
(10) Pub. No.: US 2008/0035267 A1
(43) Pub. Date: Feb. 14, 2008

(54) System and method for making a laminate

(75) Inventors: Hsien-Te Cheng, Kuei-Jen Hsiang (TW); Hsien-Sung Cheng, Kuei-Jen Hsiang (TW)

Correspondence Address: LADAS & PARRY, Suite 2100, 5670 Wilshire Boulevard, Los Angeles, CA, 90036-5679, US

(73) Assignee: XXENTRIA TECHNOLOGY MATERIALS CO., LTD.

(21) Appl. No.: 11/503,561

(22) Filed: Aug. 11, 2006

(51) Int. Cl. B29C 65/00

(52) U.S. Cl. 156/196; 156/538

(57) ABSTRACT

A system for making a laminate, which includes first and second metal layers and a core layer of a foam material sandwiched between and bonded adhesively to the first and second metal layers, is disclosed. The system includes: an extruder for extruding the core layer; an adhesive-applying unit disposed downstream of the extruder for applying an adhesive onto the extruded core layer; and a roller unit disposed downstream of the extruder for conveying the core layer and the first and second metal layers along a processing line and for pressing the core layer and the first and second metal layers into the laminate. The roller unit includes a pair of first rollers. At least one of the first rollers is formed with a first shape-forming structure corresponding to a bent structure to be formed on at least one of the first and second metal layers. A method for making the laminate is also disclosed.

### BACKGROUND OF THE INVENTION

1. Field of the Invention

This invention relates to a system for making a laminate with a bent structure, more particular to a system including a roller unit with a shape-forming structure corresponding to the bent structure. This invention also relates to a method for making the laminate with the bent structure.

2. Description of the Related Art

A laminate of a composite plate normally has a bent structure for enhancing the structural strength thereof. As shown in FIG. 1, a conventional laminate 1 with a bent structure includes first and second metal layers 111, 112, and a core layer 113 of a foam material sandwiched between the first and second metal layers 111, 112. The laminate 1 is produced by extruding the core layer 113, adhering the first and second metal layers 111, 112 onto the core layer 113 using an adhesive so as to form a composite strip, cutting the composite strip into a plurality of flat laminates 11, transferring the flat laminates 11 to a pressing machine, and pressing each of the flat laminates 11 into the laminates 1 with the bent structure. The bent structure normally includes a first compressed segment 12 and a second segment 13. With the first compressed segment 12, the laminate 1 thus formed has a rigid structure and can be stacked on a first compressed segment 12′ of another laminate 1′ so as to obtain a firmer structure (see FIG. 2).

However, production of the aforesaid laminate 1 is not a continuous process. In particular, the flat laminates 11 thus formed have to be transferred to the pressing machine to form the laminate 1 with the bent structure, which is inefficient and which results in an increase in manufacturing costs. In addition, upon pressing, since the adhesive for adhering the first and second metal layer onto the core layer has been cured, the structural strength of the adhesive is likely to be destroyed, thereby adversely affecting the adhesion property of the adhesive.

### SUMMARY OF THE INVENTION

Therefore, the object of this invention is to provide a system and a method that can continuously and efficiently make a laminate including first and second metal layers and a core layer.

According to one aspect of this invention, there is provided a system for making a laminate that includes first and second metal layers and a core layer of a foam material sandwiched between and bonded adhesively to the first and second metal layers, at least one of the first and second metal layers being pressed to form a bent structure. The system includes: an extruder for extruding the core layer; an adhesive-applying unit disposed downstream of the extruder for applying an adhesive onto the extruded core layer; and a roller unit disposed downstream of the extruder for conveying the core layer and the first and second metal layers along a processing line and for pressing the core layer and the first and second metal layers into the laminate. The roller unit includes a pair of first rollers. At least one of the first rollers is formed with a first shape-forming structure corresponding to the bent structure.

According to another aspect of this invention, there is provided a method for making a laminate. The method comprises: extruding a core layer of a foam material with upper and lower sides; applying an adhesive to the upper and lower sides of the core layer; forming a bent structure on at least one of first and second metal layers before curing the adhesive; and laminating the first and second metal layers with the core layer.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary perspective view illustrating a step of pressing a flat laminate to form a bent laminate in the prior art;

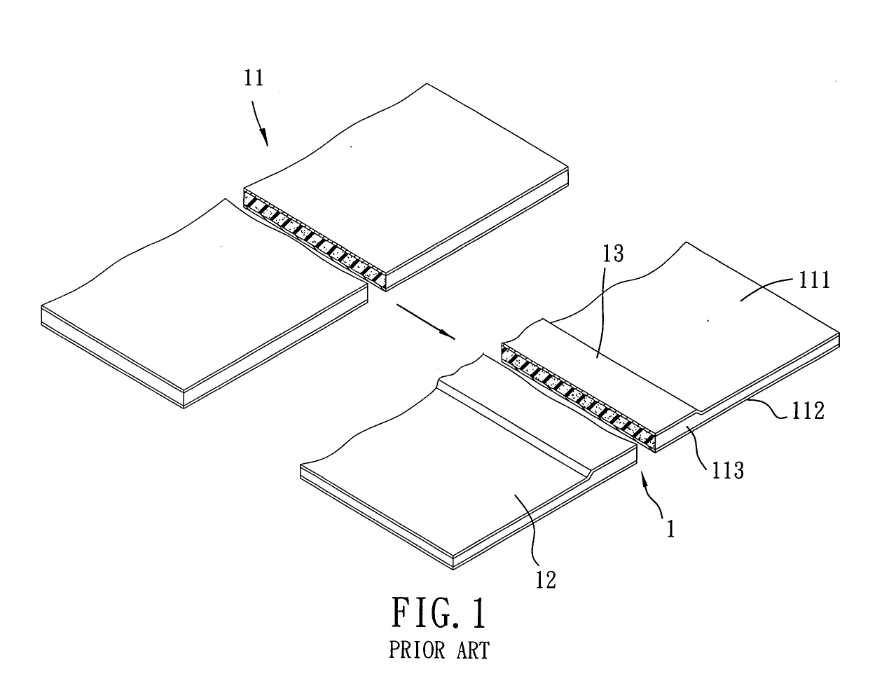

FIG. 2 is a fragmentary schematic cross-sectional view illustrating bonding of two bent laminates in the prior art;

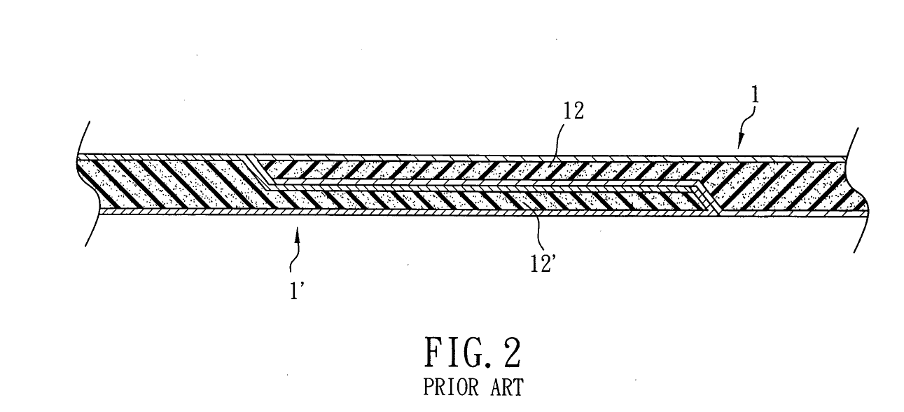

FIG. 3 is a schematic view of the first preferred embodiment of a system for making a laminate according to this invention;

FIG. 4 is a fragmentary perspective view showing a pair of first rollers of a roller unit of the first preferred embodiment and a laminate with a bent structure obtained by passing a flat laminate through the pair of first rollers;

FIG. 5 is a fragmentary perspective view showing a roller unit of the second preferred embodiment and a bent structure of the laminate obtained with the use of the same;

FIG. 6 is a schematic view of the third preferred embodiment of a system for making a laminate according to this invention;

FIG. 7 is a fragmentary perspective view showing a pair of first rollers of a roller unit of the third preferred embodiment and a metal layer with a bent structure obtained by passing a flat metal layer through the pair of first rollers;

FIG. 8 is an exploded fragmentary perspective view showing a laminate made using the third preferred embodiment of this invention;

FIG. 9 is a fragmentary schematic side view showing a laminate with a bent structure obtained using the system of this invention;

FIG. 10 is a fragmentary schematic side view showing another laminate with a bent structure obtained using the system of this invention; and

FIG. 11 is a fragmentary schematic side view showing yet another laminate with a bent structure obtained using the system of this invention.

### DETAILED DESCRIPTION OF THE PREFERRED EMBODIMENTS

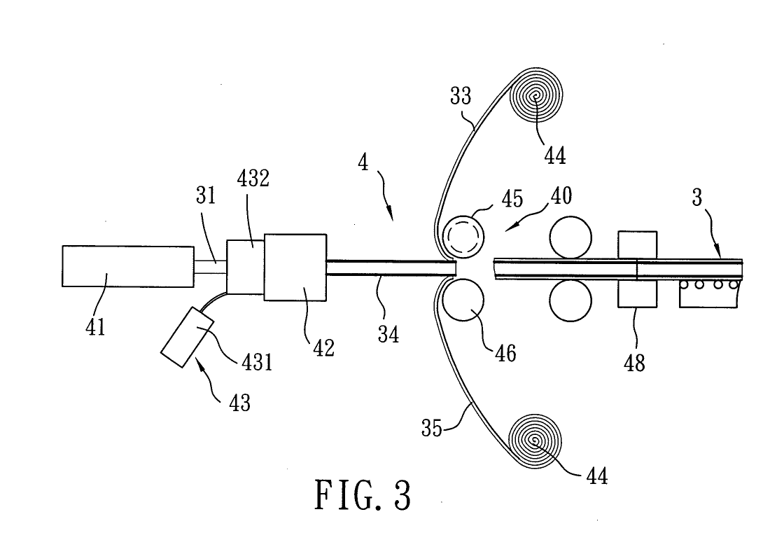

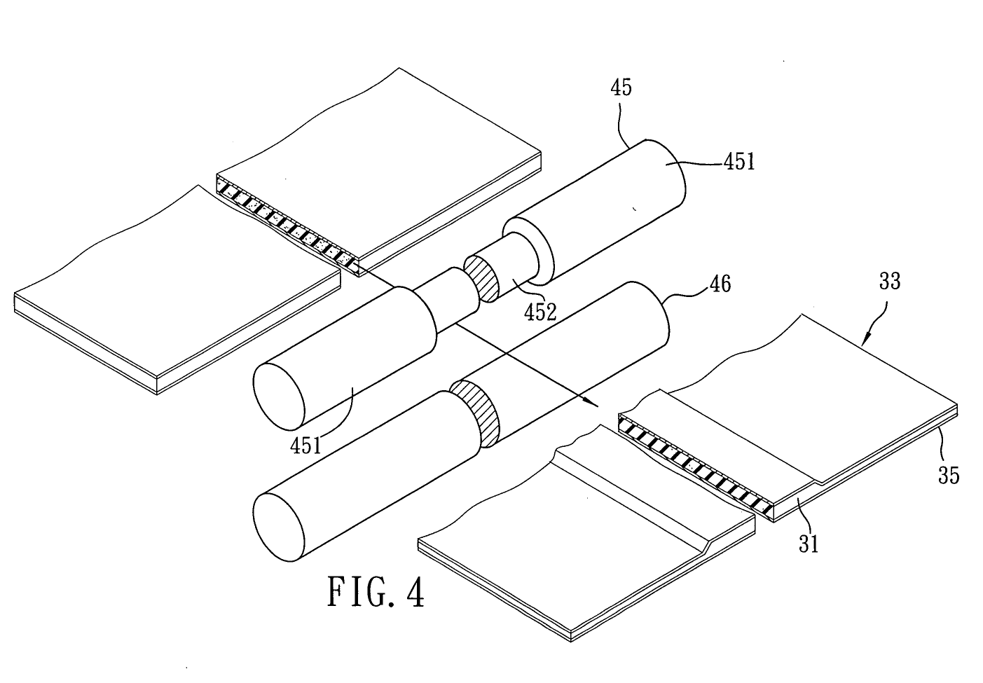

Referring to FIGS. 3 and 4, the first preferred embodiment of a system 4 according to the present invention is used for making a laminate 3 that includes first and second metal layers 33, 35 and a core layer 31 of a foam material sandwiched between and bonded adhesively to the first and second metal layers 33, 35. At least one of the first and second metal layers 33, 35 is pressed to form a bent structure (in this embodiment, the bent structure is formed on the first metal layer 33). The system 4 is shown to include: an extruder 41 for extruding the core layer 31; an adhesive-applying unit 43 disposed downstream of the extruder 41 for applying an adhesive 34 onto the extruded core layer 31; and a roller unit 40 disposed downstream of the extruder 41 for conveying the core layer 31 and the first and second metal layers 33, 35 along a processing line and for pressing the core layer 31 and the first and second metal layers 33, 35 into the laminate 3. The roller unit 40 includes a pair of first rollers 45, 46 disposed downstream of the adhesive-applying unit 43. At least one of the first rollers 45, 46 is formed with a first shape-forming structure corresponding to the bent structure.

As shown in FIG. 4, preferably, the first shape-forming structure is defined by forming a first annular groove on the first roller 45 of the roller unit 40 so as to divide the first roller 45 into two first segments 451 with a first diameter and a second segment 452 with a second diameter smaller than the first diameter of the first segments 451. The first segments 451 are spaced apart from each other by the second segment 452. The other first roller 46 is cylindrical in shape.

Referring back to FIG. 3, the core layer 31 is obtained by extruding a foamable material containing a foaming agent and a foaming aid using the extruder 41 and by passing the extrudate through an extrusion die 42 to form the core layer 31 in a sheet form. The foamable material for the core layer 31 is selected from the group consisting of polyethylene, polypropylene, ethylene-vinyl acetate copolymer, and combinations thereof. The foaming agent is selected from the group consisting of azodicarbonamide and N,N′-dinitrosopentamethylene tetraamine. The foaming aid is selected from the group consisting of zinc oxide and cadmium stearate. In addition, the metal layers 33, 35 can be selected from the group consisting of aluminum alloy sheet, zinc-plated steel sheet, aluminum zinc-plated steel sheet, aluminum zinc magnesium-plated steel sheet, titanium alloy sheet, copper alloy sheet, stainless steel sheet, zinc alloy sheet, and paint coated steel sheet.

The adhesive-applying unit 43 includes an adhesive-supplying member 431 and a distributor 432 disposed upstream of and next to the extrusion die 42. The distributor 432 receives the adhesive 34 from the adhesive-supplying member 431, and applies the adhesive 34 to upper and lower sides of the core layer 31.

The first rollers 45, 46 cooperatively define a nip that is disposed on the processing line. The first shape-forming structure confines one side of the nip. When the core layer 31 coated with the adhesive 34 and the first and second metal layer 33, 35 supplied from a metal layer-supplying unit 44 incorporated in the system 4 are conveyed to pass through the nip between the first rollers 45, 46, the first rollers 45, 46 press the first and second metal layers 33, 35 and the core layer 31 into the laminate 3, and the first roller 45 simultaneously shapes the first metal layer 33 of the laminate 3 to form the bent structure before curing the adhesive 34.

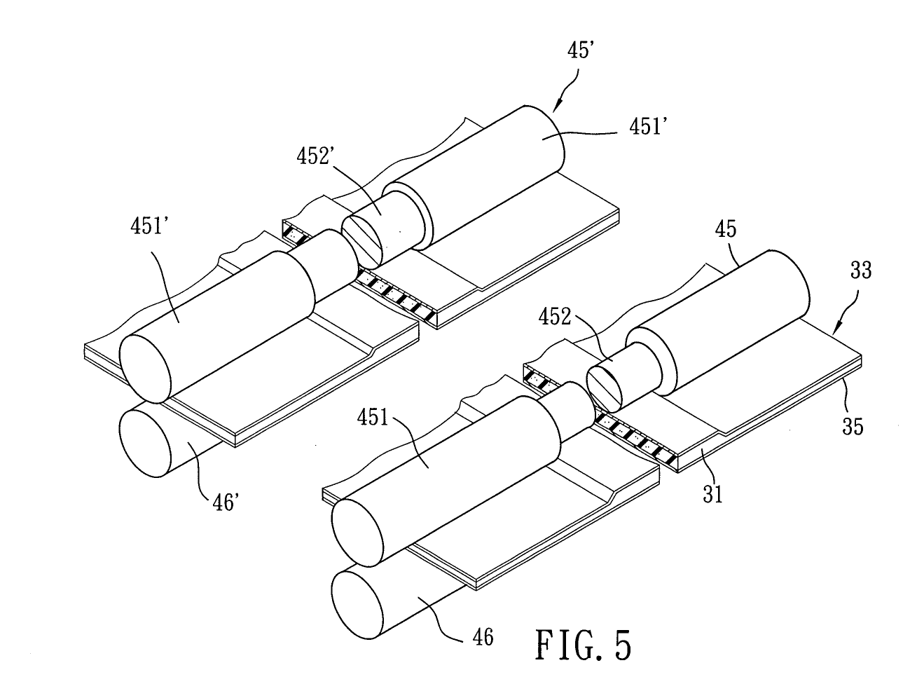

FIG. 5 illustrates the second preferred embodiment of the system according to this invention. This embodiment differs from the previous embodiment in that the roller unit 40 further includes a pair of second rollers 45′, 46′ disposed upstream of the first rollers 45, 46. One of the second rollers 45′ is formed with a second annular groove so as to define a second shape-forming structure thereon. The second roller 45′ includes two third segments 451′ with a third diameter equal to the first diameter of the first segments 451 of the first roller 45, and a fourth segment 452′ extending between the third segments 451′ and having a fourth diameter. The fourth diameter is smaller than the third diameter of the third segments 451′ and larger than the second diameter of the second segment 452 of the first roller 45. The other of the second rollers 46′ is cylindrical in shape, and is the same as the first roller 46. In this embodiment, the core layer 31 and the first and second metal layers 33, 35 are conveyed to pass through the second rollers 45′, 46′ and then through the first rollers 45, 46 so as to gradually form the bent structure on the laminate 4.

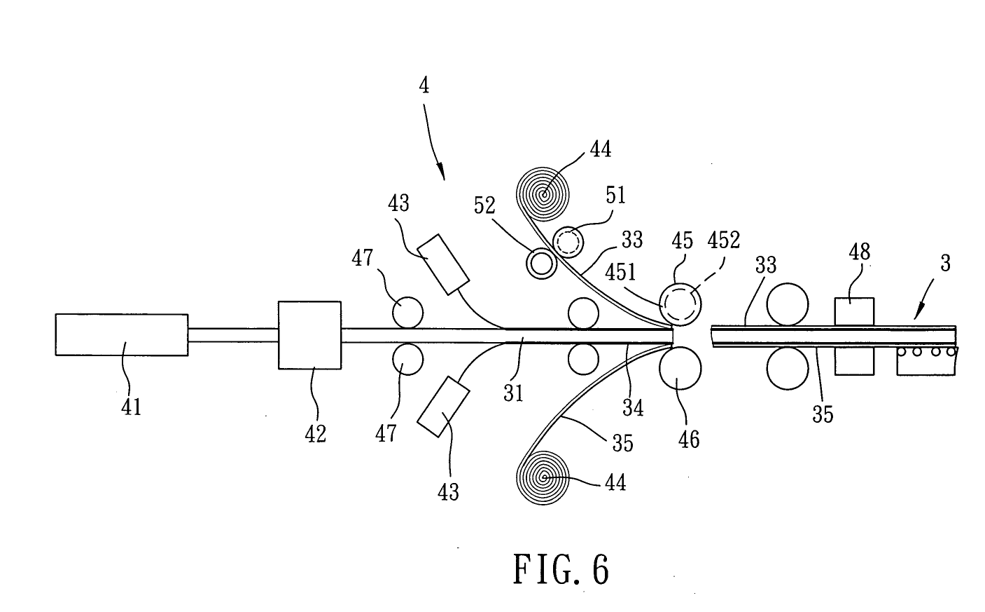

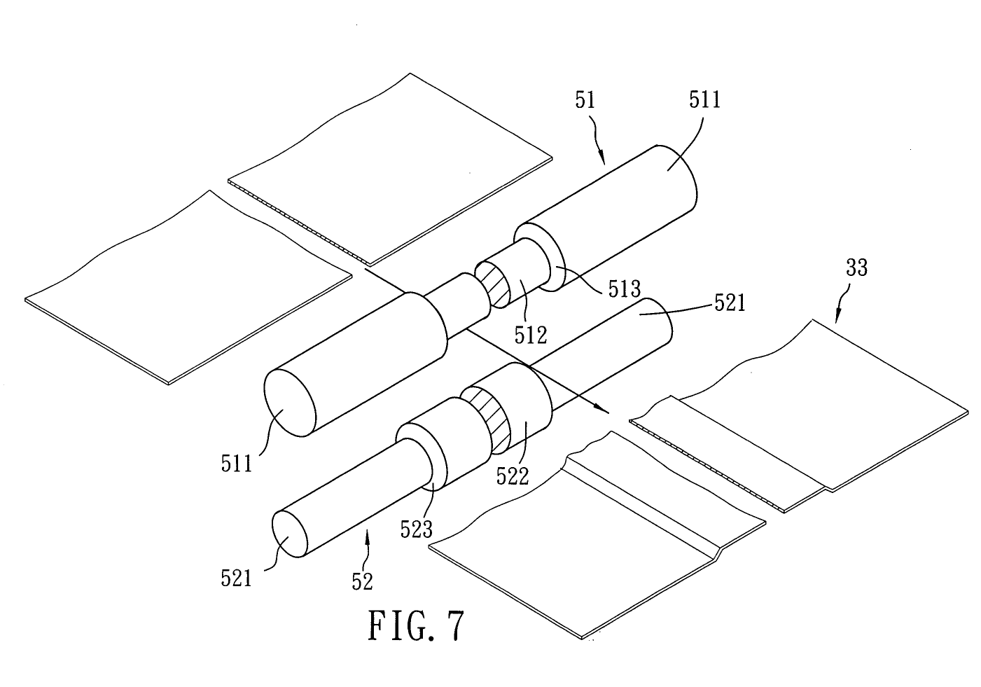

FIG. 6 shows the third preferred embodiment of the system according to this invention. This embodiment differs from the first embodiment in that the roller unit 40 further includes a pair of second rollers 51, 52 disposed upstream of the first rollers 45, 46. The second rollers 51, 52 are formed with a second shape-forming structure for pressing the first metal layer 33 into the bent structure before conveying the same to the first rollers 45, 46. As shown in FIG. 7, the second shape-forming structure on the second rollers 51, 52 is defined by forming a second annular groove 513 with a first depth on the second roller 51 and by forming a protrusion 523 with a first height on the second roller 52 corresponding to the second annular groove 513 on the second roller 51. The first depth of the second annular groove 513 is equal to the first height of the protrusion 523. Moreover, the second roller 51 has a shape and a size the same as those of the first roller 45.

In this embodiment, the roller unit 40 further includes a pair of cooling rollers 47 disposed between the extrusion die 42 and the adhesive-applying unit 43 for cooling the core layer 31 extruded from the extrusion die 42.

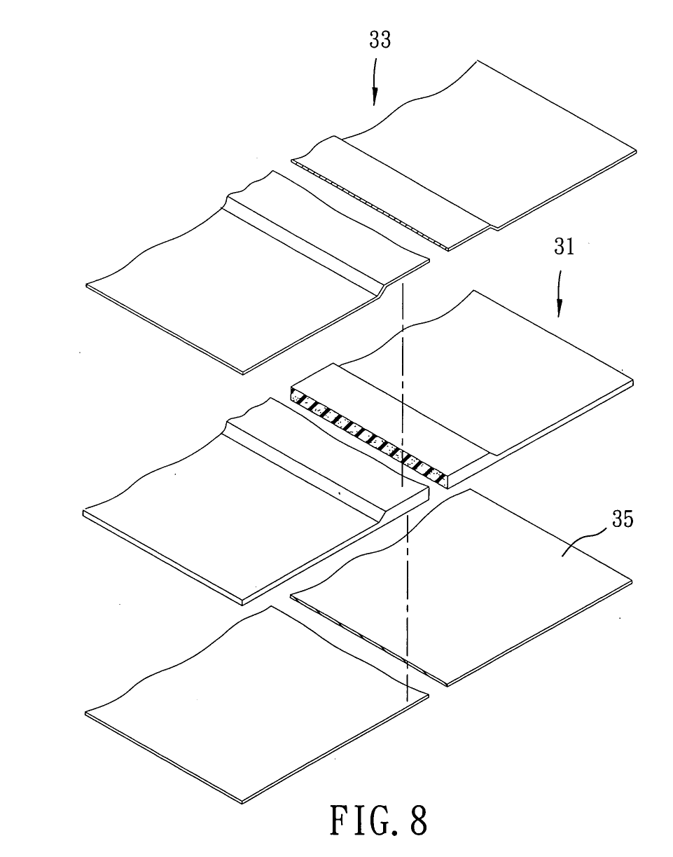

As shown in FIG. 8, in this embodiment, the core layer 31 is shaped into the bent structure before pressing with the first and second metal layers 33, 35, i.e., before curing the adhesive 34.

As shown in FIGS. 3 and 6, in this invention, the system 4 further includes a cutting unit 48 disposed downstream of the roller unit 40 for cutting the bent laminate 3 into a plurality of pieces with a desired length.

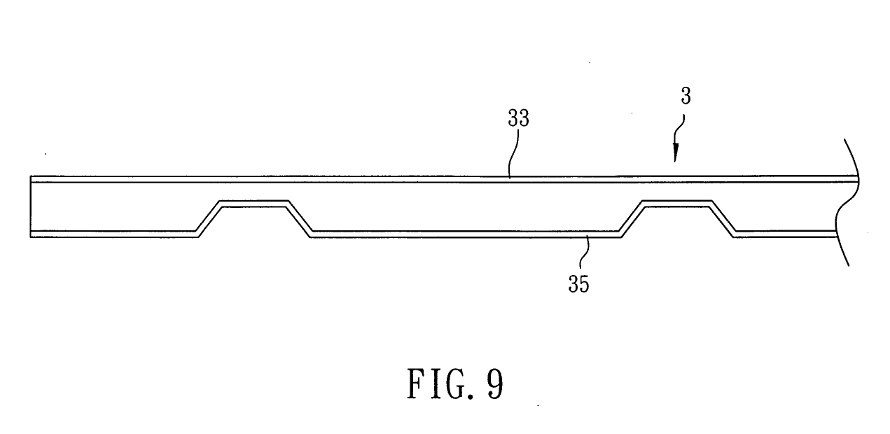

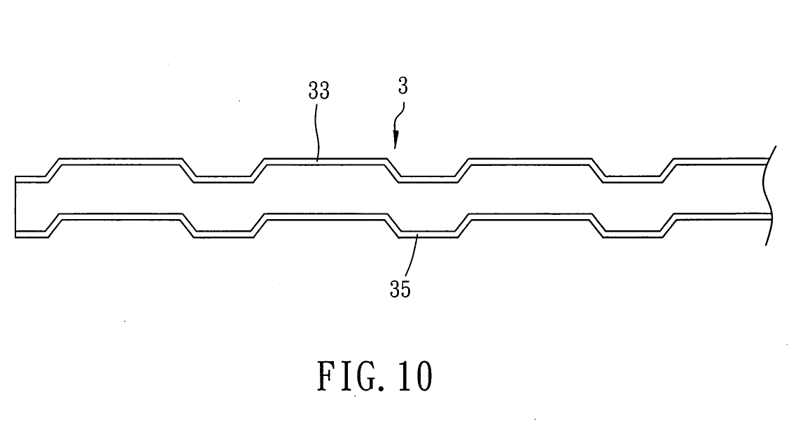

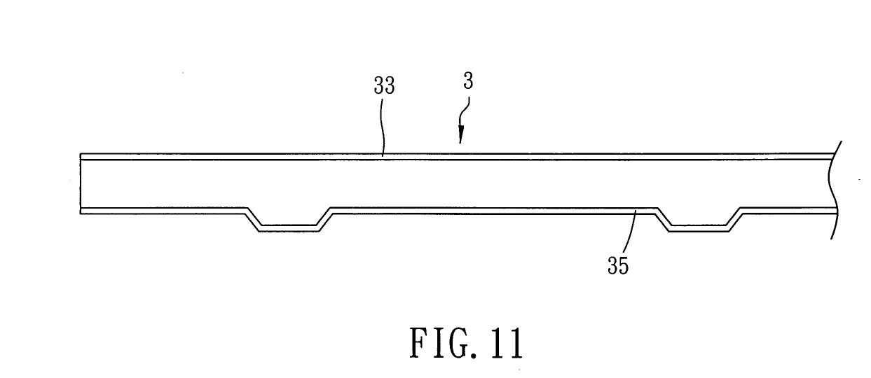

The system 4 according to this invention can be used to make various laminates having different bent structures as shown in FIGS. 9-11 by changing the shape-forming structure of the roller unit 40.

Through the system 4 and the method of this invention, the laminate 3 can be produced continuously and efficiently without destroying the adhesion property of the adhesive 34, thereby resulting in a decrease in manufacturing costs.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

1. A system for making a laminate, the laminate including first and second metal layers and a core layer sandwiched between and bonded adhesively to the first and second metal layers, at least one of the first and second metal layers being pressed to form a bent structure, said system comprising:
an extruder for extruding the core layer;
an adhesive-applying unit disposed downstream of said extruder for applying an adhesive onto the extruded core layer; and
a roller unit disposed downstream of said extruder for conveying the core layer and the first and second metal layers along a processing line and for pressing the core layer and the first and second metal layers into the laminate, said roller unit including a pair of first rollers, at least one of said first rollers being formed with a first shape-forming structure corresponding to the bent structure.

2. The system of claim 1, wherein said first shape-forming structure is defined by forming a first annular groove on said at least one of said first rollers of said roller unit so as to divide said at least one of said first rollers into two first segments with a first diameter and a second segment with a second diameter smaller than the first diameter of said first segments, said first segments being spaced apart from each other by said second segment.

3. The system of claim 2, wherein said first rollers cooperatively define a nip that is disposed on said processing line, and said first shape-forming structure confines one side of said nip so as to simultaneously shape at least one of the first and second metal layers and press the first and second metal layers and the core layer into the laminate.

4. The system of claim 3, wherein said roller unit further includes a pair of second rollers disposed upstream of said first rollers, at least one of said second rollers being formed with a second shape-forming structure defined by forming a second annular groove thereon so as to divide said at least one of said second rollers into two third segments with a third diameter equal to the first diameter of said first segments of said at least one of said first rollers, and a fourth segment extending between said third segments and having a fourth diameter, said fourth diameter being smaller than said third diameter and larger than the second diameter of said second segment of said at least one of said first rollers.

5. The system of claim 3, wherein said roller unit further includes a pair of second rollers that is disposed upstream of said first rollers and at least one of which is formed with a second shape-forming structure for pressing said at least one of the first and second metal layers into the bent structure.

6. The system of claim 5, wherein said second shape-forming structure on said second rollers is defined by forming a second annular groove with a first depth on one of said second rollers and by forming a protrusion with a first height on the other of said second rollers corresponding to said second annular groove on said one of the second rollers, said first depth of said second annular groove equaling to said first height of said protrusion, said second roller formed with said second annular groove having a shape and a size the same as those of said first roller formed with said first annular groove.

7. The system of claim 5, wherein said roller unit further includes a pair of cooling rollers disposed between said extruder and said adhesive-applying unit for cooling the core layer extruded from said extruder.

8. The system of claim 1, further comprising a cutting unit disposed downstream of said roller unit.

9. A method for making a laminate, comprising:
extruding a core layer with upper and lower sides;
applying an adhesive to the upper and lower sides of the core layer;
forming a bent structure on at least one of first and second metal layers before curing the adhesive; and
laminating the first and second metal layers with the core layer.

9. The method of claim 9, wherein the laminating step and forming step are simultaneously performed.

11. The method of claim 9, wherein the laminating step is performed after the forming step.
